(19) United States
(12) Patent Application Publication
(10) Pub. No.: US 2006/0097208 A1
(43) Pub. Date: May 11, 2006

(54) Magnetic valve

(76) Inventor: Michael John O'Brien, Warrington (GB)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/507,448

(22) PCT Filed: Mar. 13, 2003
(86) PCT No.: PCT/GB03/01065

§ 371 Date: Dec. 19, 2005

(30) Foreign Application Priority Data
Mar. 13, 2002 (GB) 0205878.2

(51) Int. Cl. F16K 31/08

(52) U.S. Cl. 251/65

(57) ABSTRACT

A magnetic valve includes a collar surrounding and defining a port and a plug. The plug is movable from a first position within the port, in which the port is wholly closed by the plug, to a second position out of the port, in which the port is not wholly closed. The plug and collar are magnetically attracted such that in the first position the plug is magnetically retained within the port.

The present invention relates to a valve, and in particular to a magnetic valve and a simple mechanical method of operation thereof. The valve can be for a container suitable for use in materials handling, particularly hazardous materials such as radioactive ones.

In the field of materials handling, it is often necessary to provide a valve which can be used to control the passage of materials from one body to another; eg from a store or conduit into a container. When hazardous materials are being handled it may be useful to be able to handle those materials remotely or so as to prevent harm to human operators. It is therefore advantageous if a valve is mechanically simple to operate. This makes operation of the valve easy to effect in a difficult working environment. Further, the simpler the operation of the valve, the less likely it will be to break down, thereby reducing the need to carry out repairs.

However, such a valve should also provide reliable closure and sealing, to prevent hazardous materials escaping. It should also minimise the chance of spillage or loss of material during transfer through the valve.

It is also advantageous if a valve can be provided which is low weight and which does not significantly affect the balance of a container such that the valve can easily be retrofitted, or used without requiring significant adaptation of existing containers or materials handling equipment.

There is therefore a need for a light, mechanically simple valve, which is easy to operate, while sealing reliably and helping to prevent spillage.

According to a first aspect of the invention, there is provided a magnetic valve including an element surrounding and defining a port and a plug moveable from a first position, in which the port is wholly closed by the plug, to a second position, in which the port is not wholly closed, and in which the plug is magnetically retained in the first position.

The use of magnetic attraction provides a particularly simple seal with only a single moving part which is mechanically simple and easy to operate so as to open or close the valve. The mechanism by which the plug is retained is effectively integrated into the valve without requiring ancillary mechanical components, thereby reducing weight and simplifying the mechanical action of the valve. This helps to reduce the number of moving members which could fail, reduces wear between multiple moving members and also allows a lightweight valve to be provided. Reducing the number of moving parts also helps to reduce failure of the valve when granular or powdered materials are being passed through the valve, and which could otherwise interfere with the operation of multiple moving parts.

The element may be or include a collar. The term collar is used interchangeably hereinafter with the term element.

The plug can generate the magnetic field. In this case, the element or a part thereof, preferably a collar is of a magnetic material.

The collar can generate a magnetic field. In this case, the plug is of a magnetic material. Preferably the collar generates a magnetic field strongly localised at the port so as to enhance retention of the plug in the port.

A permanent magnet, or plurality of permanent magnets, can provide the source of a magnetic field. Alternatively, a solenoid or similar device can be used to provide the source of a magnetic field. Permanent magnets are preferred as being a simple means for generating a magnetic field, as no ancillary equipment is required.

Preferably, the collar includes a plurality of permanent magnets disposed around the collar. The plurality of permanent magnets can be equi-angularly disposed around the collar. Preferably an even number of permanent magnets are provided. More preferably, the number of permanent magnets is 2, 4, 6, 8, 10 or 12, and most preferably 12.

The collar can include a magnetisable material. Magnetisable material can be used so as to enhance the strength of the magnetic field, particularly within the port. Preferably the shape of the magnetisable material is configured so as to localise the magnetic field strength within the port. The collar can comprise a layer of magnetisable material. The collar can include more than one layer of magnetisable material. Preferably, the collar comprises two layers of magnetisable material and a layer including a source of the magnetic field which is sandwiched between the magnetisable layers. This configuration provides a particularly suitable magnetic field pattern, strongly localised at the port of the valve.

The plug may be retained against the element and/or collar in the first position, but more preferably at least a part of the plug is retained within the port, ideally as defined by the collar.

The collar and plug can have a circular shape. The collar and plug should both have the same general shape and be dimensioned such that the plug fits tightly into the collar so as to seal the port. The collar and plug may both have a regular or irregular polygonal, rectilinear or curved shape, e.g. oval or ellipsoidal. A circular collar and plug are preferred for ease of manufacture.

A side of the plug may have a shape which helps to prevent material accumulating on that side of the plug. Preferably that shape presents no flat surface perpendicular to a direction of material flow, such that material does not accumulate on that side of the plug, and/or the directions of movement between the first and second positions.

The plug is preferably provided with a tapering component on the top or bottom of the plug. Preferably the component is provided on the bottom of the plug, that is in the direction of the second position. Preferably the component is of a generally convex nature, which is considered to include curved shapes and rectilinear shapes, including cones. A conical shape is preferred as being particularly suitable for preventing the accumulation of material. Preferably the shape is provided by a hollow component, thereby reducing the weight of the plug. Preferably the adjoining surfaces of the plug and its component are flush with one another.

One or both of the top and bottom surfaces of the plug may be recessed.

The plug can include a mating formation on a side presented to an actuator, preferably the top side. This helps ensure registration of the actuator and plug and also helps prevent lateral movement of the plug relative to the actuator thereby helping to prevent the plug disengaging from the actuator.

The valve can include a limiter which can engage the plug to limit the travel of the plug away from the collar in a first direction. The limiter limits the travel of the plug relative to the collar so as to prevent the plug becoming separated from the valve. The limiter can comprise a substantially hollow structure or frame work, so as to allow the free flow of material. The structure can include a formation providing a seat for receiving the plug.

The valve can include a stop to prevent the plug moving out of the collar. The stop enables the valve to act as a one way valve. The stop can be provided by the collar and plug having a formation which abuts against a part of the other. Preferably the formation is a lip on the plug, ideally the lip has a diameter greater than the minimum diameter of the port.

According to a further aspect of the invention, there is provided a valve mechanism, including a valve according to the first aspect of the invention and an actuator to operate the valve, the actuator including a member and driving the member in a first direction, such movement causing the member to engage a side of the plug to move the plug from the first to the second position thereby opening the valve.

An actuator driven to push the plug from the first to the second position provides simple mechanical means for operating the valve. The free end of the actuator which engages the plug does not overly restrict the flow of material through the valve.

Preferably the member of the actuator and the plug are magnetically attracted so that the plug is retained by the member when in the second position. Using magnetism to retain the plug on the free end of the actuator provides a simple mechanism with no moving parts which could be damaged by flowing materials. As the plug is retained by the actuator, the valve design is particularly simple, and no ancillary parts are required to retain the plug which would increase weight and restrict flow through the valve.

Preferably, the plug is magnetisable and the actuator generates a magnetic field. More preferably, the actuator includes a permanent magnet located at the free end of the member. Preferably the strength of magnetic interaction between the plug and member is less than the strength of magnetic interaction between the plug and collar. In this way, the member will automatically disengage from the plug when the plug is drawn back into, and retained by, the collar by the member. The strength of magnetic interaction between the plug and member should be sufficient to prevent flowing material from disengaging the plug and member.

Preferably the member of the actuator has a formation adapted to engage with a surface of the side of the plug to ensure registration of the plug and actuator. More preferably, the engaging formation also reduces movement of the plug relative to the actuator in a direction perpendicular to the direction of drive of the actuator.

A side of the member opposite to the free end can have a shape adapted to prevent material accumulating on the free end. Preferably, the shape has no flat surface substantially perpendicular to a direction of flow and/or the directions of movement between the first and second positions. The shape is preferably tapered in a direction away from the free end. Most preferably the shape is generally convex, and can include curved shapes and rectilinear shapes, including cones. Most preferably the shape is conical. The shape can be provided by a hollow formation.

The cross sectional shape of the member end and the cross sectional shape of the plug in a plane parallel to the plane of the port are preferably the same. This presents a smooth outer surface of the actuator and plug to help prevent flowing material being collected on the plug and actuator. Also, matching the size of the member of the actuator to the size of the plug can provide a wiping action on an interior surface of the collar, helping to remove material from the inner surface of the collar.

According to a third aspect of the invention, there is provided a container having a valve according to the first aspect of the invention provided on the inlet thereto.

The container can be made of a non-magnetic material. The container can be made of stainless steel. The container can be a hazardous materials handling container and preferably is suitable for handling radioactive materials. The container can have an air hammer attached to it so as to agitate the container to help empty materials from the container. The container can include a heat conducting member extending along a central longitudinal axis so as to act as a heat sink for hot materials held in the container.

Preferably the valve is attached to the container by releasable fasteners such as bolts.

According to a further aspect of the invention, there is provided a method of operating a magnetic valve having a collar defining a port and a plug magnetically retained in the port, the method including the steps of engaging a member of an actuator with the plug and driving the plug in a first direction out of the port.

The use of a magnetically retained plug means that a mechanically simple method of operation of the valve can be used which is particularly suitable for hazardous environments requiring remote operation.

According to a further aspect of the invention, there is provided a method of handling a material using a container according to the third aspect of the invention, the method including the steps of presenting the container oriented with the valve upwards to an actuator, opening the valve with the actuator, transferring the material into the container, closing the valve, inverting the orientation of the container to present the valve downwards to an actuator and opening the valve with the actuator.

The simple mechanical actuation of the valve means it is particularly suitable for handling material by pouring the material into a container through the valve and then inverting the container and opening the valve to allow the material to empty out from the container through the valve under action of gravity. The method of operation requires only a simple actuating mechanism and the transfer of materials under action of gravity reduces the mechanical parts involved in the process, thereby increasing reliability and hence reducing the need for manual intervention.

The material being handled can be hazardous. The material being handled can be a radioactive material. The material can be in powder or granular form. The material being handled can be a fuel, by-product, product or waste from a nuclear reactor, processing or reprocessing facility or other nuclear industry facility.

An embodiment of the invention will now be described, by way of example only, and with reference to the accompanying drawings, in which:

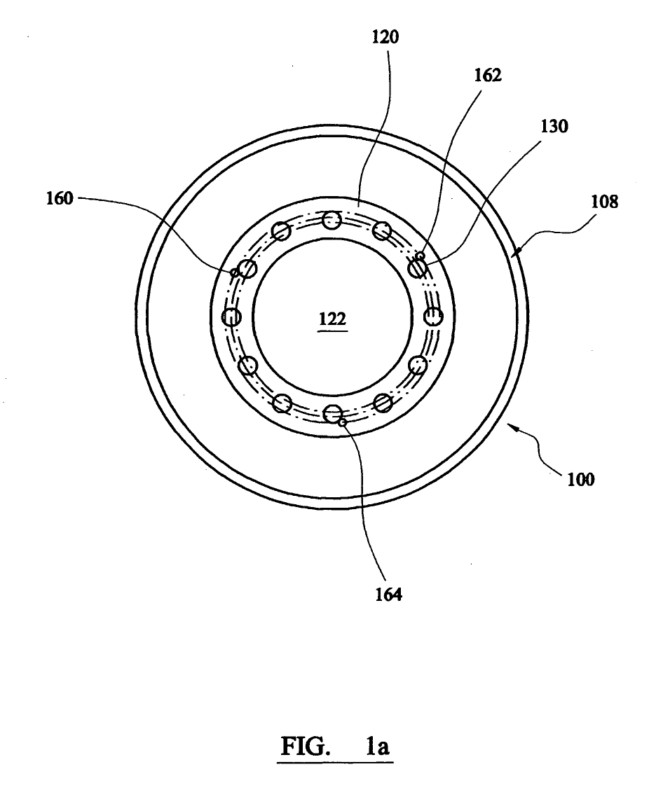

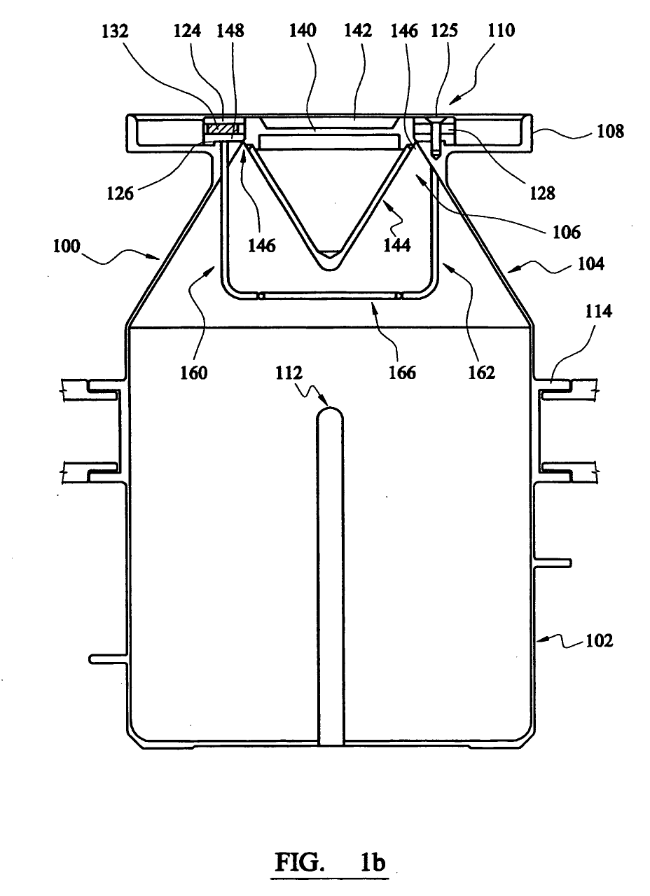

FIGS. 1a and 1b respectively show plan and cross sectional drawings of a container and valve according to the present invention;

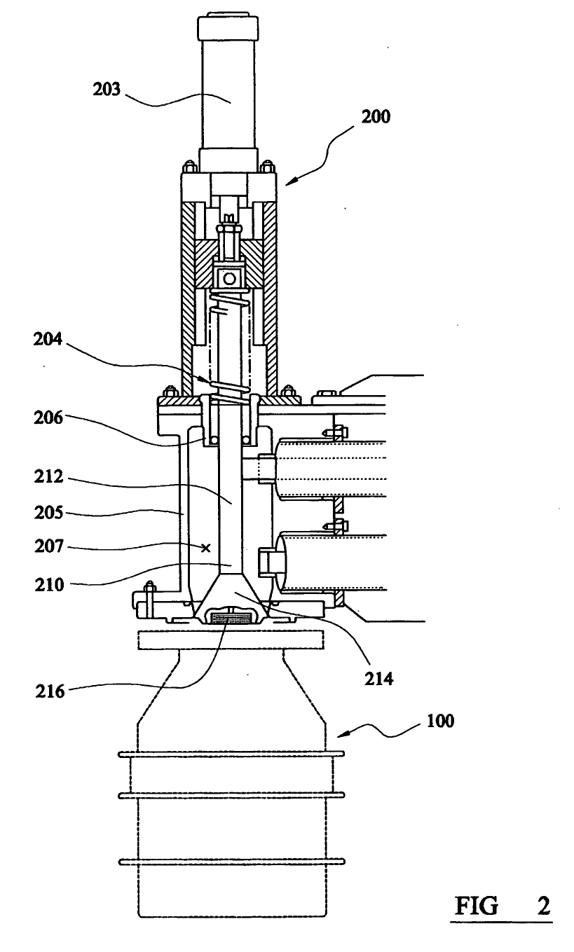

FIG. 2 shows a materials handling station including an actuator part of a valve mechanism according to the invention;

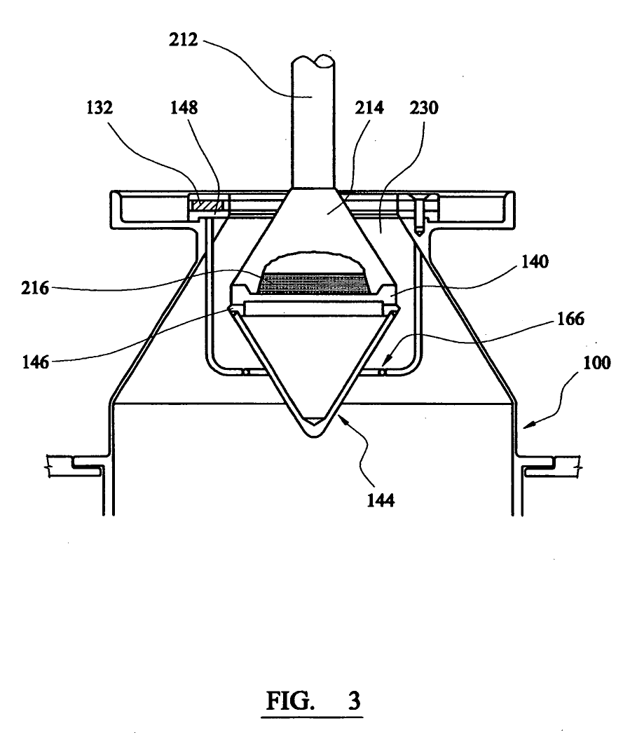

FIG. 3 shows a partial cross section of a top part of a container including a valve and valve mechanism according to the present invention in operation; and

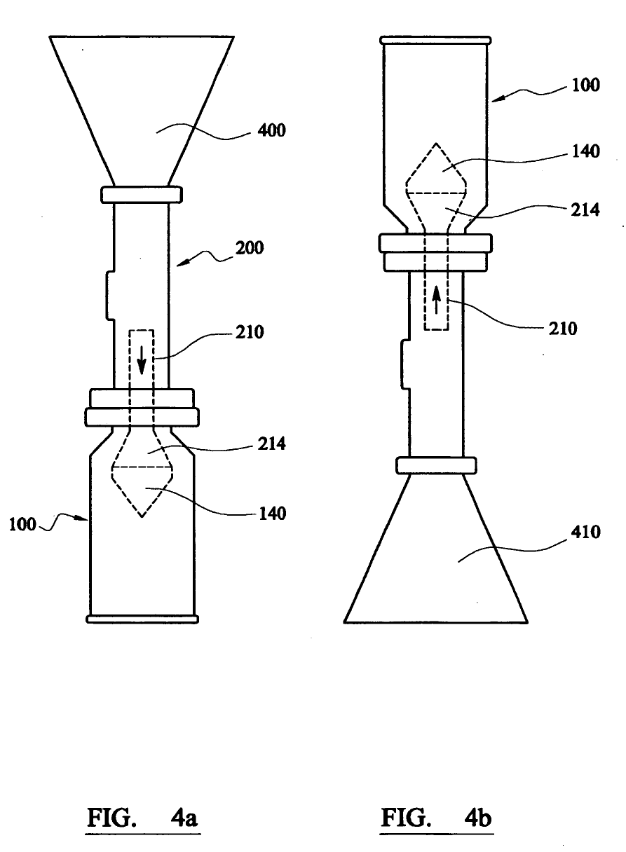

FIGS. 4a and 4b respectively show schematic diagrams illustrating a materials handling method of the present invention using a container having a valve according to aspects of the present invention.

Similar items in different Figures share common reference numerals unless indicated otherwise.

FIGS. 1a and 1b respectively show plan and cross sectional views of a container 100 including a valve 110. The container has a substantially right circular cylindrical body 102 having shoulder portion 104 at an upper end defining a neck region 106. A flanged head part 108 extends from the neck. A member 112 extends from the base of the container along a longitudinal axis and provides a heat sink. Cooling fins are provided on the exterior of the container in some cases and handling formations 114 are also provided to facilitate handling of the container. The container is manufactured of non-magnetic stainless steel.

Such a container is particularly suitable for handling granular and powdered materials, such as plutonium oxide and uranium oxide as used in nuclear industries. Such a container is also suited to handling residues and other components from recycling operations in the nuclear industry.

Valve 110 includes a circular collar 120 located around the neck of the container and which defines a port 122 for the container. Collar 120 is comprised of three circular rings. A first ring 124 is made of ferritic stainless steel and includes a number of counter-sunk apertures each for receiving a fixing bolt 125. A second ring 126 is also made of ferritic stainless steel, and includes a number of apertures in registration with the apertures in the first ring to allow the fixing bolts to pass therethrough. A third ring, 128, which is sandwiched between rings 124 and 126, is made of non-magnetic stainless steel and includes twelve cavities 130 equi-angularly spaced in a generally circular pattern around the ring. Each of these receives a disc of permanently magnetised material 132. The collar 120 is fastened to the container by a number of fixing bolts 125 (not shown in FIG. 1a) which engage with a threaded portion of the head of the container 108. The distribution of permanent magnets sandwiched between layers of magnetisable material generates a strong magnetic field spatially localised within the port 122 of the valve.

The valve also includes a plug 140 (not shown in FIG. 1a). The plug is also made of ferritic stainless steel and is hence attracted by magnets. The plug has a generally circular disc like shape and fits tightly into port 122. An upper side of plug 140 includes a recess 142 providing a formation for engaging with an actuator as will be described later. A part of an underside of the plug is machined away to reduce the overall weight of the plug. A hollow non-magnetic stainless steel cone 144 is attached to an underside of the plug and points in a direction along the longitudinal axis of the container.

The outer peripheral edge of the plug includes a lip 146 having a circumference slightly larger than the circumference of the port such that it stands proud and can abut against a part of the inner edge of the second ring 126. This provides a mechanical stop preventing movement of the plug out of the port in a direction away from the container along the longitudinal axis of the container.

First, second and third L-shaped arms 160, 162, 164 project downwardly from the collar into the container forming a support for a circular ring 166. Circular ring 166 is positioned concentric to the longitudinal axis of the container and of the plug 140. The diameter of ring 166 is less than the maximum diameter of plug 140 and provides a seat in which plug 140 can be held to limit movement of the plug 140 into the container 100. These features do not contribute to the normal operations of the container, but act to assist in maintenance and to provide an emergency arrester ring.

With reference to FIG. 2, there is shown a filling station 200 at which a container 100 (shown in ghost lines) is presented, and including an actuator 210. The filling station includes a housing 205 defining a chamber 207 in which a cylindrical elongate member 212 of the actuator is located. An hydraulic (or pneumatic) ram arrangement 203 is attached to one end of the member 212 to provide a drive means to drive the actuator in a first direction. A return spring 204 is provided to return the actuator in a second direction and a sealing arrangement 206 is provide to isolate the driving components from the chamber 207.

The free end of the actuator 210 has a member 214 substantially circular conical shape. A circular, disc shaped permanent magnet 216 is located on the surface of the member 214. The maximum diameter of the member 214 is slightly larger than the diameter of the outlet of the chamber 207 and in the position shown, seals chamber 207.

FIG. 3 illustrates the valve in operation. The underside of the member 214 of the actuator is shaped to mate with recess 142 in the upper surface of plug 140. Permanent magnet 216 located at the surface of the member 214 has substantially the same diameter as the recessed portion 142 as illustrated by the cut away part of the member 214.

Operation of the valve will now be described. With the valve in a first closed position, as illustrated in FIG. 1b, the plug 140 wholly occupies the port 122 within the collar 110. The container is therefore effectively sealed. The strong magnetic field produced in the locale of the port by the effect of the permanent magnets 130 and rings of magnetic material 124 and 126 generates sufficient force to firmly retain the plug 140 within port 122.

In order to operate the valve, actuator 210 is driven toward the upper, exposed side of the plug and the member 214 of the actuator engages in recess 142 thereby ensuring correct registration of the actuator and plug. The actuator is then driven along the longitudinal axis of the container to overcome the magnetic attraction between the plug and collar. The plug is disengaged from the collar and moves along the longitudinal axis. The plug is retained on the member by magnetic interaction between permanent magnet 216 and the magnetisable material of the body of the plug 140. The plug no longer seals the port and therefore the valve is in an open configuration with the plug in a second position.

Material can then pass into the container through the valve under action of gravity. The tapered shape of the member 214 does not hinder the flow of material into the container through the annular gap 230. Further, as no flat surfaces perpendicular to the general direction of flow are presented by the actuator, material does not tend to accumulate on the actuator. The mating formation on the member cooperates with the recess in the plug to help prevent the plug from being dislodged from the actuator by forces lateral to the longitudinal axis.

In the event that the plug is dislodged from the actuator, the travel of the plug is limited by ring 166 which provides a seat in which the plug is retained to prevent the plug from being lost in the deep interior of the container. Further, the ring and cone shape cooperate to effectively align the plug concentrically, and in registration with, the port and actuator so that the plug can easily be recovered.

In order to close the valve, the actuator is returned in the opposite direction along the longitudinal axis of the container by the action of the spring. As the plug is a tight fit in the port of the collar, any material located on the outer edge of the plug is effectively wiped off the plug and retained in the container. Lip 146 engages and abuts the portion 148 of the collar and provides a mechanical stop to prevent further movement of the plug out of the container. The actuator continues its movement and disengages from the plug which is retained in the collar by the strong magnetic interaction between the collar and plug.

With reference to FIGS. 4a and 4b there is illustrated a method of handling hazardous material utilising a container and valve according to the invention. FIG. 4a schematically illustrates a hopper 400 holding a hazardous material to be transported. Part 200 represents a filling station similar to that shown in FIG. 2 and including an actuator 210. A container 100 is presented to the filling station in an upright orientation with the valve upwardly. The valve is opened by driving the actuator along the longitudinal axis of the container in a direction toward the interior of the container, such that the plug is dislodged from the port and moves into the container, thereby providing a flow path by which material falls under gravity into the container. The plug 140 is retained on the actuator by the magnetic interaction between the plug and actuator. When the material has been transferred, the actuator is driven in the opposite direction thereby closing the valve. The plug member is retained in the port by the magnetic interaction of the collar and plug and the actuator disengages from the plug and re-seals the chamber of the filling station.

FIG. 4b illustrates an emptying station including a storage hopper 410 and emptying apparatus similar to that shown in FIG. 2 but inverted. Container 100 is presented to the emptying station in an inverted orientation with the valve pointing downwardly. Actuator 210 is driven along the longitudinal axis of the container, in a direction towards the interior of the container, and removes plug 140 from port 122 and moves it toward the interior of the container. This opens the valve and material in the container falls under action of gravity through the substantially annular flow path around plug 140 and free end 214 of the actuator. The conical shape of the underside of the plug helps to ensure that material does not collect on the plug thereby ensuring complete transfer of material from the container. Agitation of the container can be used to help to dislodge compacted powders and help ensure complete transfer of the contents. An air hammer or similar device is preferably attached to the container to provide such agitation.

When the container has emptied, the actuator is driven in the opposite direction thereby closing the valve as the plug is moved back into the port and is retained therein by the magnetic interaction of the plug and collar.

It will be appreciated that the valve of the present invention provides a particularly simple mechanical system with a reduced number of moving parts by relying on magnetic interactions rather than mechanical interactions. Although a mechanical stop is used in this particular embodiment, it will be appreciated that by arranging the relative strengths of the magnetic interaction between the plug and collar and plug and actuator appropriately, the mechanical stop can be omitted.

As the valve and actuator arrangement allows a closed materials transfer to be accomplished, it is particularly suitable for handling hazardous materials such as those used in nuclear industries, although it is not limited to such materials. The valve, valve mechanism and container are all suitable for use in any industry in which the advantages of a simple mechanical valve with reduced number of moving parts would be appropriate.

1. A magnetic valve comprising a collar surrounding and defining a port and a plug movable from a first position within the port, in which the port is wholly closed by the plug, to a second position out of the port, in which the port is not wholly closed, and in which the plug and collar are magnetically attracted such that in the first position the plug is magnetically retained within the port, and wherein a first side of the plug has a convex shape.

2. A magnetic valve according to claim 1 which the first side of the plug has no flat surfaces perpendicular to the direction of material flow through the port.

3. A magnetic valve according to claim 1 in which the first side of the plug is conical.

4. A magnetic valve according to claim 3 in which the conical plug is hollow.

5. A valve as claimed in claim 1, in which a magnetic field is generated by the plug.

6. A valve as claimed in claim 1, in which a magnetic field is generated by the collar.

7. A valve as claimed in claim 1, in which a permanent magnet is the source of the magnetic field.

8. A valve as claimed in claim 7, in which the collar includes a plurality of permanent magnets disposed around the port.

9. A valve as claimed in claim 1, and including a limiter depending away from the collar which can engage the plug to limit the travel of the plug away from the collar in a first direction.

10. A valve as claimed in claim 1, and including a stop which prevents the plug being moved from the first position in a second direction.

11. A valve mechanism comprising a valve and an actuator to operate the valve, the valve being a magnetic valve including a collar surrounding and defining a port and a plug movable from a first position within the port, in which the port is wholly closed by the plug, to a second position out of the port, in which the port is not wholly closed, and in which the plug and collar are magnetically attracted such that in the first position the plug is magnetically retained within the port, and wherein a first side of the plug has a convex shape, the actuator including a member which, when the member is driven in a first direction, engages a side of the plug to move the plug from the first to the second position thereby opening the valve.

12. A valve mechanism as claimed in claim 11, in which the member and the plug are magnetically attracted, such that the plug is retained by the member when in the second position.

13. A valve mechanism as claimed in claim 11, in which a second side of the member opposite to the side which engages the plug has a convex shape.

14. A valve mechanism as claimed in claim 13 in which the second side has no flat surfaces perpendicular to the direction of flow of material through the port.

15. A valve mechanism as claimed in claim 13 in which the second side is conical.

16. A valve mechanism as claimed in claim 13 in which the second side of the actuator and the first side of the plug define a smooth outer surface.

17. A container having a valve, the valve being a magnetic valve including a collar surrounding and defining a port and a plug movable from a first position within the port, in which the port is wholly closed by the plug, to a second position out of the port, in which the port is not wholly closed, and in which the plug and collar are magnetically attracted such that in the first position the plug is magnetically retained within the port, and wherein a first side of the plug has a convex shape.

18. A container according to claim 17 in which the first side of the plug has no flat surfaces perpendicular to the direction of material flow through the port.

19. A container according to claim 17 in which the member and the plug are magnetically attracted, such that the plug is retained by the member when in the second position.

20. A method of operating a magnetic valve having a collar defining a port and a plug magnetically retained in the port, the method comprising the steps of engaging an actuator member with a first side of the plug and driving the plug in a first direction out of the port, wherein a first side of the plug has a convex shape so as to help prevent material accumulating on the first side of the plug.

21. A method of handling a material using a container, the container having a valve, the valve being a magnetic valve including a collar surrounding and defining a port and a plug movable from a first position within the port, in which the port is wholly closed by the plug, to a second position out of the port, in which the port is not wholly closed, and in which the plug and collar are magnetically attracted such that in the first position the plug is magnetically retained within the port, and wherein a first side of the plug has a convex shape, the method comprising the steps of presenting the container oriented with the valve upwards to an actuator;
opening the valve with the actuator;
transferring the material into the container;
closing the valve;
inverting the orientation of the container to present the valve downwards to an actuator;
and opening the valve with an actuator.
